(19) United States
(12) Patent Application Publication
(10) Pub. No.: US 2018/0089152 A1
(43) Pub. Date: Mar. 29, 2018

(54) MESSAGE TEXT LABELLING

(71) Applicant: Digital Genius Limited, London (GB)

(72) Inventors: Bogdan Maksak, London (GB); Jose Marcos Rodriguez Fernandez, London (GB); Conan McMurtie, London (GB); Mahyar Bordbar, London (GB)

(21) Appl. No.: 15/696,058

(22) Filed: Sep. 5, 2017

(30) Foreign Application Priority Data
Sep. 2, 2016 (GB) 1614958.5

(51) Int. Cl. G06F 17/21; G06F 17/27; G10L 25/30

(52) U.S. Cl. CPC G06F 17/218; G10L 25/30; G06F 17/2785

(57) ABSTRACT

This is provided a method of labelling a message or group of messages. An input is received (208) at a neural network (300, 302) including at least one recurrent layer, which may comprises LSTM memory blocks (300). The input comprising at least one word vector (xₜ), which represents at least one word in a message, and the at least one word vector defines a meaningful position in a word vector space. Typically the input is a sequence of word vectors corresponding to a sequence of words. The input is then processed to generate a plurality of network outputs. Each network output corresponds to a respective one of a plurality of labels. Based on the network outputs, a probability score for each of the labels is then generated (210). If it is determined (212) that at least one of the probability scores meets at least one criterion, the at least one label corresponding to the at least one probability score for which the at least one criterion is met is assigned (214) to the message.

### CROSS-REFERENCE TO RELATED APPLICATION

The present application claims priority to GB Patent Application No. 1614958.5 filed on Sep. 2, 2016, entitled “MESSAGE TEXT LABELLING” the entire disclosure of which is incorporated by reference herein.

### FIELD OF THE INVENTION

The invention relates to a method of labelling message text using a recurrent neural network. The invention also relates to training such a network, and to a labelling system for labelling message text using a recurrent neural network.

### BACKGROUND

Many companies receive a large volume of messages. A message may be part of a chain of messages, that is, a conversation. Messages have to be categorised and responded to. Some attributes of a message, such as the identity of a sender, enable some automatic categorisation of the message, but it is typically desirable to categorise messages using labels that conventionally have to be determined by a human operator. For example, where a category, such as topic, has several possible labels, it may be necessary for the human operator to determine the relevant label for the message and input an indication of the relevant label. For example, where the category relates to topic, each label may relate to a particular one of a plurality of topics. Where the category relates to urgency of need to resolve the subject to which the message relates, each label may include an indication of a degree of urgency. This categorising of messages requires time on the part of the operator. The time required cumulatively by all human operators in an organisation to correctly label messages may be high and thus the cost to an organisation in applying labels to messages is also high.

Messages are sometimes submitted via an online web interface. In this case, the online interface may require a sender to indicate particular labels for the message. However, sometimes such indications may not be accurate, or the sender may not be well placed to provide such labels.

It is an object of the present invention to address the above-mentioned issues.

### SUMMARY OF THE INVENTION

In accordance with a first aspect of the present invention, there is provided a method of labelling a message or group of messages, comprising: receiving an input at a neural network including at least one recurrent layer, the input comprising at least one word vector, the at least one word vector representing at least one word in a message, and wherein the at least one word vector defines a meaningful position in a word vector space; processing the input, by the neural network including the at least one recurrent layer, to generate a plurality of network outputs, wherein each network output corresponds to a respective one of a plurality of labels; generating, based on the network outputs, a probability score for each of the labels; determining if at least one of the probability scores meets at least one criterion; if the at least one is criterion is met, assigning the at least one label corresponding to the at least one probability score for which the at least one criterion is met to the message.

Thus, a label may be automatically assigned to a message without need for action by a human operator. This method reduces the need for human operators to label messages or groups of messages.

If the at least one criterion is not met, a status indicator may be assigned to the message indicating that none of the labels has been assigned. Accordingly, the at least one criterion may be configured so that a label is only assigned where the probability scores indicate that there is a high likelihood of correct assignment.

In accordance with a second aspect of the present invention, there is provided a labelling system for labelling a message or a group of messages, comprising: a neural network layer, including at least one recurrent layer, configured to: receive an input, the input comprising at least one word vector, the at least one word vector representing at least one word in a message, and wherein the at least one word vector defines a meaningful position in a word vector space; process the input to generate a plurality of network outputs, wherein each network output corresponds to a respective one of a plurality of labels; a probability distribution means configured to generate, based on the network outputs, a probability score for each of the labels; label determining means configured to: determine if at least one of the probability scores meets at least one criterion, and if the at least one is criterion is met, assigning the at least one label corresponding to the at least one probability score for which the at least one criterion is met to the message.

In accordance with a third aspect of the present invention method of training a neural network including at least one recurrent layer, comprising: receiving an input at the neural network, the input comprising at least one word vector, the at least one word vector representing at least one word in a message to which one of a plurality of possible labels has been assigned, and wherein the at least one word vector defines a meaningful position in a word vector space; processing the input to generate a plurality of network outputs, wherein each network output corresponds to a respective one of a plurality of labels; generating, based on the network outputs, a probability score for each of the labels; comparing the probability score for the labels against ground truth values for each label; updating at least weights of the neural network using one or more back propagation methods based at least on a result of the comparison. The method may further comprise updating the at least one word vector using one or more back propagation methods based at least on a result of the comparison. The at least one word comprises a sequence of words and the at least one word vector may comprise a sequence of word vectors, wherein the sequence of word vectors represents the sequence of words, and wherein the word vectors have meaningful positions relative to one another in the word vector space.

Other optional and/or preferred features are set out in the dependent claims.

### BRIEF DESCRIPTION OF THE FIGURES

For better understanding of the present invention, embodiments will now be described, by way of example only, with reference to the accompanying Figures in which:

FIG. 1 shows diagrammatically functional software elements in a message handling system that relate to embodiments of the invention;

FIG. 2 is flowchart indicating steps that take place in assigning a label to a message;

FIG. 3 shows illustratively aspects of a network layer and a probability determination layer;

FIG. 4 shows diagrammatically an exemplary LSTM unit;

FIG. 5 is a flowchart indicating steps that take place in training an LSTM network for use in embodiments of the invention; and

FIG. 6 is a diagram of an exemplary computer system.

### DETAILED DESCRIPTION OF EMBODIMENTS

Like reference numerals are used to denote like parts throughout.

Embodiments of the invention relate to categorisation of messages by using recurrent neural networks to assign labels to messages or to a group of messages. Such a group of messages may be a conversation, or the messages may be otherwise related, for example by relating to a same case in a customer relations system or to the same customer.

Embodiments are not limited to any particular kind of message text or conversation, provided the words in the message or conversation are machine readable. For example, the messages may be any one or more of SMS (short message service) messages, emails, instant messaging service messages, messages sent over online social networking services such as Twitter®, and messages submitted using an online form provided in a web browser. The messages may be received and/or sent messages. Conversations are groups of messages. Groups of messages may be sent between two or more entities. Such entities may include people, or computerised agents configured to generate messages automatically. Messages may relate to voice conversation that has been pre-transcribed in a prior step, or be handwritten text that has been processed in a prior step.

Embodiments of the invention may be implemented in a message handling system, for example for use by a company in communication with customers. The message handling system may be part of a customer relations system.

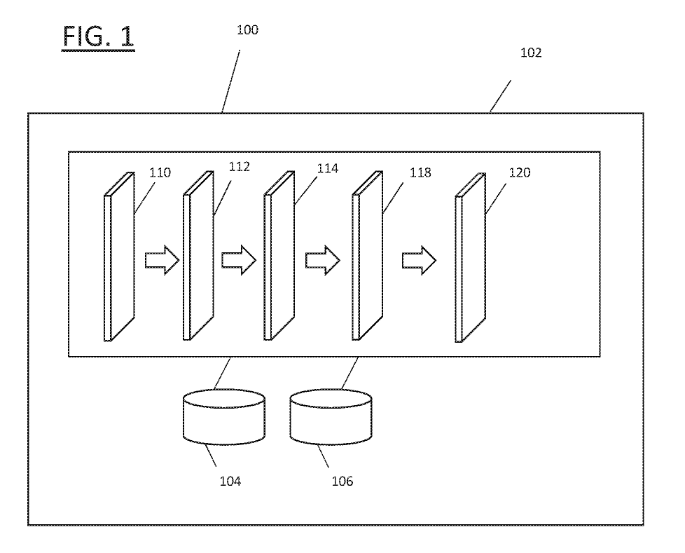

Referring to FIG. 1, the message handling system 100 includes a labelling engine 102, a message data store 104 and a vocabulary store 106. The labelling engine 102 is configured to process messages, to determine, for each message, a probability score that each of a plurality of labels is applicable to the respective message, and, if one of the probability scores exceeds a threshold score, to assign the label to the message. The labelling engine 102 has several functional layers, including a message processing layer 110, a vocabulary layer 112, a network layer 114, a probability determination layer 118 and a label determination layer 120. As will be appreciated by the skilled person, these functional layers are implemented as one or more computer programs typically comprising one or more modules.

The message data store 104 stores messages and one or more labels for each message to which one or more labels have been assigned. The message data store 104 also typically stores other data relating to the messages, for example, an identifier of the sender of each message, dates and times of receiving and sending of message, et cetera.

The vocabulary store 106 is a word table comprising words used in messages. Each word is associated with a one-hot vector that is unique relative to the one-hot vectors of all the other words. Thus, the one-hot vector of each word enables that word to be distinguished from every other word. The word table may be generated using a tokenisation module (not shown), and may also include one-hot vectors corresponding to punctuation marks and terms that may not strictly be words but are to be considered as words herein. The one-hot vectors are each in the form of a one-dimensional matrix all of the same length, the length being at least equal to the number of words. Each entry in the one-dimensional matrix consists of a zero, except one, which consists of a “1”. The number of dimensions of each one-hot vector is typically high given that the number of words may be large and may be comparable to the number of words in a dictionary.

The network layer 114 includes a configured (that is, trained) word representation matrix, a trained LSTM network and a final, fully-connected, feedforward layer. The word representative matrix 106 together with the word table enable a word vector to be associated with each word in the vocabulary store 104. The matrix comprises a word vector for each word in the vocabulary table. The number (n) of dimensions of each word vector is the same and is defined by the programmer. Typically, the number of dimensions is at least 200 and fewer than 500. The word vectors define positions in an n-dimensional vector space such that their relative positions are meaningful. That is, words that share common contexts are located in close proximity to one another in the vector space.

The network layer 114 is configured to receive as an input a sequence of word vectors corresponding to a sequence of words in a message. The number of words in a sequence is not limited since the LSTM network unrolls to accommodate the number of word vectors to be input. This means that the whole of the textual content of a message can be input. The textual content of a group of messages can be concatenated and input as a single input. The input may be a single word vector corresponding to one word.

Alternatively, the number of word vectors in a sequence may comprise a maximum number of words, for example 100. In this case, only the first 100 consecutive words may be used. A group of sentences is a “batch”. In an alternative, the number and size of batches that are input to the network layer 14 can be controlled. Alternatively, consecutive groups of words may be processed in turn, and a probability score obtained for each label for each group. The probability score for each label can then be averaged using an average method and the resultant scores used in determining whether a label is to be assigned. The network layer 114 is configured to process the sequence of word vectors in a stepwise manner, each at a respective time step, and to generate a predetermined plurality of network outputs, there being one network output for each label in a category. The network layer 114 is described in greater detail below.

The probably determination layer 118 is configured to receive the network outputs and to determine a probability score indicative of the likelihood of each of the predefined labels being applicable to the message text whose words were input to the labelling engine 102. The probability determination layer 118 is implemented using a softmax function. The network outputs are vectors defining positions in the vector space. The softmax function squashes the network output for each label into a value in a range (0, 1) and where the sum of the values is 1. Alternatively, the probability determination layer 118 can be implemented using hierarchical softmax.

The label determination layer 120 is configured to process the probability scores. If one of the probability scores is greater than a predetermined threshold score, the label determination layer 120 is configured to assign the label to which the probability score corresponds to the message. If none of the probability scores is greater than the threshold score, the label determination layer 120 is configured to provide a status to the message indicating that the message requires labelling by a human operator. This is so that a label is only automatically assigned to a message where there is an appropriately high likelihood of the correct label having been determined by the labelling engine 102. In alternative embodiments, the label determination layer 120 may simply assign the label having the highest probability score to the message.

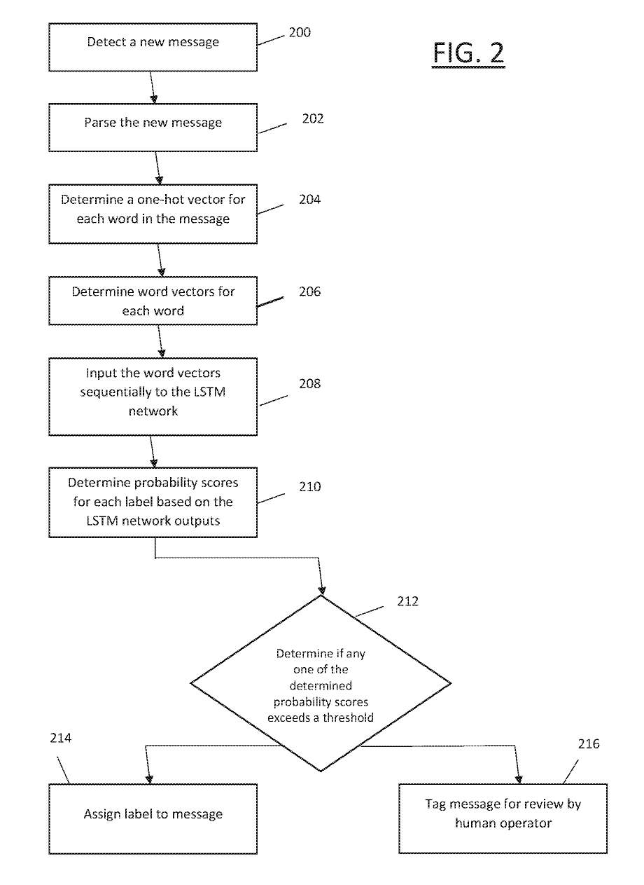

Operation of the labelling engine 102 will now be described. Initially, new messages are received and stored in the message data store 104. Referring to FIG. 2, the labelling engine 102 then detects that a new, unprocessed message is present in the message data store 104. At step 202, at the message processing layer 110 the labelling engine 100 parses the message into a string of text and that text is tokenised into a sequence of words. At step 204, at the vocabulary layer 112 the labelling engine 100 determines a one-hot vector for each word in the sequence using the vocabulary table. The one-hot vectors are listed in a matrix to retain the order of the sequence of words.

The network layer 114 then determines at step 206 a word vector for each word using the one-hot vectors, by determining the matrix product of the one-hot vector and the word vector matrix. The result is a matrix listing sequentially the word vector for each word. It is to be noted that the use of the word table and the word representation matrix in combination is an efficient way of generating such a matrix or list of word vectors corresponding to the sequence of words in the message, but in variant embodiments, the word vector for each word may be determined using other processes.

If any word is not present in the word vector matrix, the network layer 114 is configured to generate a word vector having only values of zero. The network layer 114 is configured to process the zeros to ignore the input word vector.

The word vectors are then received at the network layer 114 in temporal sequence and processed in turn at step 206 to yield a network output for each label.

The network output is processed by the probability distribution layer 118 to result in a fractional probability score associated with each of the labels at step 208. The probability scores represent a probability of the respective labels being applicable to the input sequence of words. The probability scores are processed so that they sum to 1.

The label determination layer 120 then determines at step 212 if any of the probability scores are above the threshold score. If any of the probability scores is above the threshold score, the label determination layer 120 assigns, at step 214 the label corresponding to the score to the message and stores an indication of the label in the message data store 104. If no probability score above the threshold is determined, a status indicator is assigned to the message indicating that no label has been assigned. A label is then preferably assigned by a human operator. In one example, the threshold score is 0.9, corresponding to 90%. If the probability score for a label is 0.95, that label is assigned to the message. If the probability score is 0.85, no label will be assigned.

The threshold score is preferably configurable. Thus, the number of messages tagged for review by a human operator can be controlled against the number of labels that may be assigned in error. In variant embodiments, different labels may have different threshold scores associated with them. This may be reflective of the seriousness of problems that may be caused by a label being erroneously assigned.

Exceeding of the threshold score is one criterion to be met in order for the relevant label to be automatically assigned. In embodiments, other criteria may be configured. For example, in addition to the probability score for one of the labels exceeding the threshold score, there may be a requirement that, where the number of labels is greater than two, the probability scores for all other labels are less than a further threshold score.

Each of the labels relates to a particular category and is one of at least two labels defined for that category. In an embodiment, more than one category is defined, each having a respective plurality of labels associated with them. In this case, other criteria that may be configured to be met for automatic assignment of a label may be that a particular label in a category other than the category of the label to which the probability score relates may be required. In other words, criteria may be configured requiring dependency for automated assignment of a label in one category on assignment of a particular label in another category.

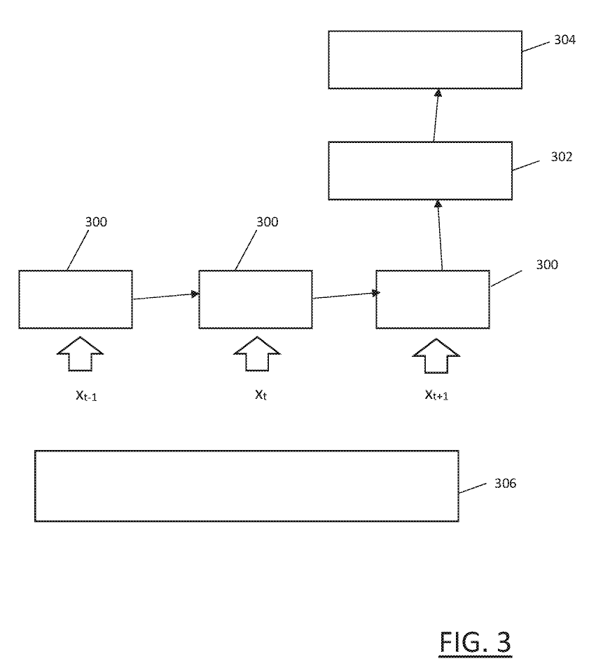

Referring to FIG. 3, one LSTM layer is indicated, although there may be a plurality of connected layers. The one or more layers each includes a plurality of LSTM memory blocks. Each LSTM memory block includes one or more cells that each include an input gate, a forget gate and an output gate, which allow the cell to store previous states for the cell. At each cell a non-linear activation function is applied to inputs to the cell to generate an output. The stored previous state may be used in generating a current activation value. Each of the gates has a respective parameter (or “weight”) associated with it, by which the flow of information through the gate is controlled. Each weight is adjusted during training of the LSTM network.

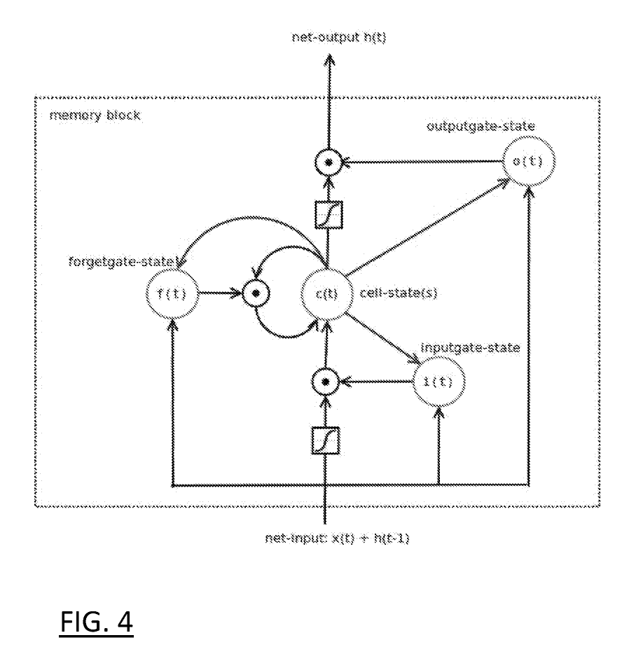

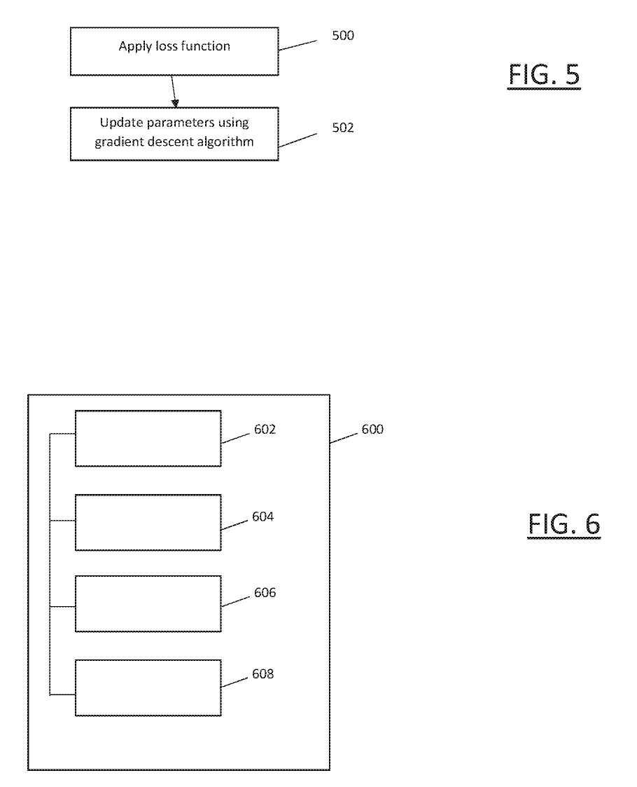

An example LSTM memory block 300 is shown in FIG. 4. Configuration and operation of LSTM memory blocks are known in the art. Each LSTM memory block 300 has as inputs the word vector (xₜ), where t is the location of the word vector in the sequence of word vectors, and hₜ₋₁, which is an output of the previous LSTM block that processed the word vector (xₜ₋₁). Each LSTM memory block 300 shown in FIG. 3 can be considered as one or a stack (not illustrated), where each block in the stack processes a value for a particular dimension for the word vector space. Where an input word vector has n dimensions, the stack has a corresponding size.

The gating mechanism is defined by the following equations:

iₜ=σ(Wᵢ−xₜ+Uᵢ−hₜ₋₁) (Equation 1)

fₜ=σ(W_{f}−xₜ+U_{f}−hₜ₋₁) (Equation 2)

oₜ=σ(Wₒ−xₜ+Uₒ−hₜ₋₁) (Equation 3)

oₜ=tan h(W_{c}−xₜ+U_{c}−hₜ₋₁) (Equation 4)

It follows that the cell state is defined by:

cₜ=fᵢcₜ₋₁+iₜ−\tilde{c}ₜ₋₁ (Equation 5)

And the hidden state of the block is defined by:

hₜ=cₜ−tan h(cₜ) (Equation 6)

In these equations, W and U are weight matrices which enable a linear transformation of a present input and a previous output. xₜ and hₜ₋₁, correspond to a present input and to the previous output. σ is a logistic function as described below. A bias term is included by increasing the dimension of the matrices by one and appending a value of one to the inputs. Equations (5) and (6) define how the output is calculated from the gates from equations (1) through (4)

The LSTM network shown in FIG. 3 also has a linear feedforward layer in the form of a multilayer perceptron (MLP) 302. This reduces the number of outputs of the network layer 114 to correspond to the number of labels.

The i-th output of a single layer of the MLP is:

$${x}_{i} = φ ( {\sum }_{j = 1}^{n} {w}_{ij} - {b}_{i} ) \qquad ( Equation 7 )$$

Where φ is an activation function. The activation function may be any one of a number of activation functions, for example:

(a) a logistic activation function:

$$φ ( x ) = \begin{matrix}1 \\ \overline{1} - {e}^{- x}\end{matrix}$$

(b) hyperbolic tangent activation function:

$$φ ( x ) = \begin{matrix}{e}^{x} - {e}^{- x} \\ \overline{{e}^{x}} + {e}^{- x}\end{matrix}$$

(c) a rectified linear unit:

φ(x)=max(x_Q)

In the probability determination layer 118, the probability distribution may, as mentioned above, be obtained using a softmax function:

$$P ( y = j \vert x ) = \frac{{e}^{{x}^{T} {w}_{z}}}{{\sum }_{j = 1}^{L} {e}^{{x}^{T} {w}_{j}}} \qquad ( Equation 8 )$$

where L is the number of labels.

The LSTM network may also include one or more intermediate layers (“hidden layers”) of LSTM memory blocks.

Configuration of recurrent neural networks (RNNs) including or consisting exclusively of LSTM memory blocks is known in the art. LSTM memory blocks that are variants on the LSTM memory blocks shown may be used and are known in the art, for example gated recurrent units (GRU). Embodiments of the invention are not limited to RNNs formed of LSTM memory blocks. Other kinds of neural network blocks may be used preferably a memory mechanism. Additionally, the RNN may in embodiments include layers that are not RNN layers, for example, the RNN may include one or more of any of: a feedforward layer in addition to the MLP layers, convolution layers, pooling layers, regularisation layers such as dropout layer, a batch normalisation layer, et cetera. In some variant embodiments, the RNN may be bidirectional.

The number of labels may be limited to two, or may be greater than two. In embodiments, the number of labels may be limited to one, in which case a probability score is also generated indicative that no label is to be applied, so that the probability scores may sum to 1.

The number of categories for which one or more labels are to be assigned for message text is not limited. Separate network, probability determination and label determination layers 114, 118, 120 may be provided for each category.

In embodiments where a category is defined for urgency relating to need to resolve a matter, the labels comprise a plurality of terms each indicative of a different degree of urgency. In a category defined for sentiment expressed in the message, the labels may comprises a plurality of terms each indicative of a different sentiment of a sender (typically the customer) of the message. In this case, the number of labels may be two, one label for positive sentiment and another for negative sentiment. Greater than two labels may also be defined for sentiment; for example labels may be defined as “angry”, “happy” and “relieved”, et cetera. Labels may also be defined according to topic, or sub-topic. The sub-topic may be dependent on a particular topic determined using the labelling engine 102.

By way of illustrative example, a customer may send the following message to the customer service system “My baggage has been lost. My medication is in it”. Receipt of such an initial message initiates a new case and the message and subsequent messages relating to the initial message are stored by the customer relations system in association with the case. The customer services system has five predefined categories. These categories are, followed by the label that will be assigned by the labelling engine 102:

(1) case phase, which is post-flight;

(2) case topic, which is lost baggage;

(3) case sub-topic, which is medication;

(4) urgency of need for resolution, which is high;

(5) sentiment, which is positive.

In an embodiment, a label change detection module may also be provided configured to detect a change of label assigned to messages received from a particular individual or entity and to perform an action if a change is detected. For example, in an embodiment in which the labelling engine 102 is implemented in a customer relations system, each message received from a particular sender is monitored and a label relating to sentiment is assigned. The customer relations system is configured to monitor the labels for a change of sentiment in the messages of the sender, and to perform an action if the sentiment changes, for example from positive to negative. The action may be to send a notification to a particular person, such as a manager, for example. Change of need for urgency of resolution of a matter may also usefully be detected.

Before the labelling engine can be used to generate accurate probability scores, the network layer has to be trained, that is, weights (parameters) for the LSTM network, the MLP and position vectors for the word representation matrix have to be determined so that the probability scores are sufficiently accurate to be useful.

In embodiments, a corpus of messages is available similar to the messages stored in the message data store 104. Such messages may have been sent and received before the labelling engine 102 described herein is implemented and at least some messages in the corpus of messages each have a label relating to a category, where the label has been assigned by human operators. The vocabulary store 106 is preferably generated from the words in those messages, with a word and an associated one-hot vector being provided for each unique word. Messages sent and received before the labelling engine 102 is implemented may be stored in the message data store 104 or elsewhere. In alternative embodiments, the vocabulary store 106 may not be generated from messages, but may be alternatively generated; for example the words in the word table may correspond to words in a dictionary.

The corpus of messages can be used for training both the word representation matrix, the MLP layers and the LSTM network. Weights and values for the position vectors are initially assigned randomly, pseudo-randomly, or in any other way. Processing of one of these messages is now described. First, the message is processed as described with reference to steps 200 to 210. This results in distribution of probability scores for each label.

The training engine applies a backwards propagation method including calculating a gradient of a loss function at step 500 with respect to all the weights and the vector positions. The loss function compares the output of the probability score distribution with the actual distribution for that message. The actual distribution comprises a probability of “1” (the ground truth value) for the label that was assigned by a human operator, and of “0” for the one or more labels that were not assigned. The loss function is preferably a cross-entropy loss function, although it known in the art to use other kinds of loss function in neural network training.

At step 502, the parameters of the LSTM network and the word vectors are updated. Using a gradient descent method. A detailed explanation of updating of the weights and the word positions is outside the scope of this description; various gradient descent optimiser methods will be known to persons skilled in the art, for example those based on stochastic gradient descent, a (Nesterov) Momentum Method, AdaGrad, AdaDelta and rmsprop. Using some methods, the learning rate per-weight may be adjusted for each parameter, for example when using rmsprop. The gradient descent optimiser algorithm changes parameter gradients for the LSTM memory blocks of the network. The RNN may be trained on individual messages from the corpus having labels assigned by a human operator, or be trained on a batch of such messages. In the latter case, zero masking may be used so that parameters can be updated where the sequences of input words are of different lengths.

Where the input word vector includes only zeros, the LSTM network is configured with respect to the back propagation so that no relevance is assigned to the loss that is backpropagated.

Preferably, each LSTM layer is initially trained separately, and then the LSTM network comprising the layers is trained as a whole.

Although it is preferred for the word representation matrix and the LSTM network to be trained together, in alternative embodiments, the word representation matrix may be trained separately from the LSTM network using a training tool provided by a third party or otherwise developed separately. The word representation matrix may be trained on the corpus of messages, applying similar techniques to those applied when training the LSTM network and the word representation matrix together.

In other alternative embodiments, the word representation matrix may be acquired from elsewhere. For example, Google publishes a word vector representations matrix pre-trained on part of the Google News dataset, which comprises about 100 billion words. This pre-trained matrix contains 300-dimensional word vectors for three million words and phrases. It is however preferred where the corpus of messages is a sufficient size, for the word representation matrix to be created using it, as the word representation matrix labelling engine will ultimately yield more accurate probability scores.

The processes described above are implemented by computer programs. The computer programs comprise computer program code. The computer programs are stored on one or more computer readable storage media and may be located in one or more physical locations.

The computer programs may be implemented in any one or more of a number of computer programming languages, for example using Python and Torch, bridged by PyTorch. When run on one or more processors, the computer programs are configured to enable the functionality described herein.

As will be apparent to a person skilled in the art, the processes described herein may be carried out by executing suitable computer program code on any computing device suitable for executing such code and meeting suitable minimum processing and memory requirements. For example, the computing device may be a server or a personal computer. Some components of such a computing device are now described with reference to FIG. 6. In practice such a computing device will have a great number of components. The computer system 600 comprises a processor 602, computer readable storage media 604 and input/output interfaces 606, all operatively interconnected with one or more busses. The computer system 600 may include a plurality of processors or a plurality of memories 604, operatively connected.

The processor 602 may be a conventional central processing unit (CPU). The computer readable storage media 604 may comprise volatile and non-volatile, removable and non-removable media. Examples of such media include ROM, RAM, EEPROM, flash memory or other solid state memory technology, optical storage media, or any other media that can be used to store the desired information including the computer program code and to which the processor 602 has access.

As an alternative to being implemented in software, the computer programs may be implemented in hardware, for example special purpose logic circuitry such as field programmable gate array or an application specific integrated circuit. Alternatively, the computer programs may implemented in a combination of hardware and software.

The input/out interfaces 608 allow coupling of input/output devices, such as a keyboard, a pointer device, a display, et cetera.

It will be appreciated by persons skilled in the art that various modifications are possible to the embodiments.

In the specification the term “comprising” shall be construed to mean that features and/or steps are included, but do not necessarily consist exclusively of, unless the context dictates otherwise. This definition also applies to variations on the term “comprising” such as “comprise” and*“comprises”.

The applicant hereby discloses in isolation each individual feature or step described herein and any combination of two or more such features, to the extent that such features or steps or combinations of features and/or steps are capable of being carried out based on the present specification as a whole in the light of the common general knowledge of a person skilled in the art, irrespective of whether such features or steps or combinations of features and/or steps solve any problems disclosed herein, and without limitation to the scope of the claims. The applicant indicates that aspects of the present invention may consist of any such individual feature or step or combination of features and/or steps. In view of the foregoing description it will be evident to a person skilled in the art that various modifications may be made within the scope of the invention.

1. A method of labelling a message or group of messages, comprising:
receiving an input at a neural network including at least one recurrent layer, the input comprising at least one word vector, the at least one word vector representing at least one word in a message, and wherein the at least one word vector defines a meaningful position in a word vector space;
processing the input by the neural network including the at least one recurrent layer to generate a plurality of network outputs, wherein each network output corresponds to a respective one of a plurality of predetermined labels;
generating, based on the network outputs, a probability score for each of the labels;
determining if at least one of the probability scores meets at least one criterion;
if the at least one is criterion is met, assigning the at least one label corresponding to the at least one probability score for which the at least one criterion is met to the message.

2. The method of claim 1, comprising, if the at least one criterion is not met, assigning a status indicator to the message that none of the labels has been assigned.

3. The method of claim 1, wherein the at least one word comprises a sequence of words and the at least one word vector comprises a sequence of word vectors, wherein the sequence of word vectors represents the sequence of words, wherein the word vectors have meaningful positions relative to one another in the word vector space.

4. The method of claim 3, wherein the sequence of words comprises some or all words in a message received at a message handling system.

5. The method of claim 1, wherein the sequence of words comprises some or all words in a group of related messages.

6. The method of claim 3, wherein the processing the input comprises:
processing the sequence of word vectors each at a respective sequential time step at the one or more recurrent neural network layers;
processing of outputs of the recurrent neural network by a fully connected linear layer to generate the network outputs.

7. The method of claim 1, wherein the determining if the at least one of the probability scores meets the at least one criterion comprises comparing each of the probability scores to at least one threshold value, and determining whether the at least one criterion is met based on a result of the comparison.

8. The method of claim 7, wherein each label has a respective threshold value associated with it.

9. The method of claim 1, wherein the or each recurrent layer comprises a plurality of memory blocks, wherein each memory block includes a memory mechanism.

10. The method of claim 9, wherein each of the memory blocks has a long short-term memory architecture or a gated recurrent unit architecture.

11. The method of claim 1, wherein the plurality of labels are respectively indicative of:
degrees of urgency of need for resolution of a subject of the message;
types of sentiment expressed in the message;
different themes or topics of the message.

12. The method of claim 1, wherein the message forms part of a chain of messages, wherein the input at the recurrent neural network comprises data indicative of a sequence of a plurality of word vectors, the sequence representing a sequence of words including words from at least two messages in the chain.

13. A method of monitoring a change of label assigned to received messages, comprising:
assigning a label to a first message indicative of a first sentiment using the method of claim 1;
assigning a second label to a second message indicative of a second sentiment using the method of claim 1;
determining that the second label is different to the first label;
further to said determining, causing at least one action to be performed.

14. The method of claim 13, wherein the labels are indicative of different sentiments.

15. A computer implemented labelling system for labelling a message or a group of messages, comprising:
a neural network layer, including at least one recurrent layer, configured to:
receive an input, the input comprising at least one word vector, the at least one word vector representing at least one word in a message, and wherein the at least one word vector defines a meaningful position in a word vector space;
process the input to generate a plurality of network outputs, wherein each network output corresponds to a respective one of a plurality of labels;
a probability distribution layer configured to generate, based on the network outputs, a probability score for each of the labels;
label determining layer configured to:
determine if at least one of the probability scores meets at least one criterion, and
if the at least one is criterion is met, assigning the at least one label corresponding to the at least one probability score for which the at least one criterion is met to the message.
